(19) United States
(12) Patent Application Publication
(10) Pub. No.: US 2025/0340491 A1
(43) Pub. Date: Nov. 6, 2025

(54) SHAPED MATERIAL AND MANUFACTURING METHOD THEREOF

(71) Applicant: Brembo S.p.A., Curno, Bergamo (IT)

(72) Inventors: Omar CIVIDINI, Curno, Bergamo (IT); Massimo ROSA, Curno, Bergamo (IT)

(21) Appl. No.: 18/871,616

(22) PCT Filed: Jun. 1, 2023
(86) PCT No.: PCT/IB2023/055627

§ 371 Date: Dec. 4, 2024

(30) Foreign Application Priority Data
Jun. 7, 2022 (IT) 102022000012008

(51) Int. Cl. C04B 35/83; C04B 41/00; C04B 41/45; C04B 41/87; C04B 111/00; F16D 65/12; F16D 69/02

(52) U.S. Cl. CPC C04B 35/83; C04B 41/009; C04B 41/4523; C04B 41/87; F16D 65/126; F16D 69/023; C04B 2111/00362; C04B 2235/48; C04B 2235/77; F16D 2200/0047

(57) ABSTRACT

The present invention relates to a shaped material comprising an inner layer made of a carbon-based material, referred to as “Carbon-Carbon” or “C/C”, and respective outer layers made of a carbon-ceramic material comprising carbon and silicon carbide, preferably said material being shaped to form a disc brake disc.

### FIELD OF THE INVENTION

The present invention relates to a shaped material, a disc brake disc made from said shaped material, and a method for manufacturing said shaped material.

### BACKGROUND ART

The use of disc brake discs made of carbon-based materials, so-called “Carbon-Carbon” or “C/C”, is known.

These are composite materials consisting of a carbon matrix in which reinforcing carbon fibers are arranged.

Discs made of “C/C” material are obtained by means of a process including the superimposition of layers or sheets of carbon fibers in the form of woven fabric and/or non-woven fabric or the use of short fibers to form a so-called carbonaceous “preform”, the possible addition of resins, possible subsequent heat treatments, and carbon densification processes. The latter can be carried out in various manners, e.g., by CVD (Chemical Vapor Deposition), (Chemical Vapor Infiltration), LPI (Liquid Polymer CVI Infiltration), PIP (Polymer Infiltration and Pyrolysis), or impregnation with resin and/or pitch, all of which lead to an increase in density such as to give adequate mechanical, thermal and tribological properties to the material, e.g., a density increase of 2 to 6 times.

To function as a friction material, the “C/C” material needs high application temperatures, which make the discs made of “C/C” material particularly suitable for being used in racing and aviation applications. Other features of discs made of “C/C” material that make them suitable for the aforesaid applications are lightweight and high thermal conductivity.

However, discs made of “C/C” material have the following disadvantages.

First, they are particularly subject to wear phenomena at the braking bands. In addition to inevitably affecting the durability of the discs, such wear phenomena contribute to the emission of carbon particulate matter into the atmosphere, with negative consequences for the environment and human health.

Moreover, such discs have limited application since they can only be used with carbon pads.

The use of disc brake discs entirely made of carbon-ceramic material is also well known. They overcome the drawbacks of discs made of “C/C” material, being very durable, little subject to wear phenomena, and usable with a wider range of pads. They are typically intended for high-performance road applications.

However, discs made of carbon-ceramic material lose the advantageous features associated with the “C/C” material, first and foremost lightness. Moreover, discs made of carbon-ceramic material are more difficult to process and require simpler geometries than discs made of “C/C” material.

Therefore, the problem underlying the present invention is to provide a shaped material as well as a disc brake disc having both the advantageous features of discs made of “C/C” material and those of discs made of carbon-ceramic material, and a process for obtaining it which is conveniently feasible.

### SUMMARY OF THE INVENTION

The problem presented above is solved by a shaped material, a manufacturing method thereof, and a disc brake disc made from said shaped material, as outlined in the appended claims, the definitions of which form an integral part of the present description.

The invention first relates to a shaped material comprising:
an inner layer made of a carbon-based material referred to as “Carbon-Carbon” or “C/C”, and
respective outer layers made of a carbon-ceramic material comprising carbon and silicon carbide, a first outer layer and a second outer layer, respectively.

The present invention secondly relates to a disc brake disc made from the aforesaid shaped material, comprising:
a first braking band formed by said first outer layer of the shaped material, said first braking band being delimited by a first braking surface intended to cooperate with a brake pad and by a corresponding inner surface,
a second braking band formed by said second outer layer of the shaped material, said second braking band being delimited by a second braking surface intended to cooperate with a brake pad and by a corresponding inner surface,
a disc core formed by said inner layer of the shaped material, which extends between the inner surfaces of said first braking band and said second braking band.

The present invention further relates to a method for making the aforesaid shaped material, comprising the following steps in sequence:
a) preparing a carbon-densified blank of “C/C” material, said blank having two opposite surfaces, a first surface and a second surface, respectively;
b) optionally making ventilation and/or feeding channels characterizing a disc brake disc;
c) putting the first surface and the second surface of said carbon-densified blank of “C/C” material into contact with silicon, either simultaneously or sequentially, so that at least part of the silicon infiltrates said blank for a predetermined thickness from said first surface (“first thickness”) and for a predetermined thickness from said second surface (“second thickness”), thus obtaining a shaped material comprising said first outer layer and said second outer layer made of a carbon-ceramic material comprising carbon and silicon carbide;
d) optionally, subjecting to finishing the shaped material obtained in step c).

The shaped material by the present invention, as well as the corresponding disc brake disc, advantageously has the typical lightness, thermal conductivity, and processability of a “C/C” material while exhibiting a higher wear resistance, which allows drastically reducing particulate emissions into the atmosphere with positive consequences for the environment and human health.

Moreover, the disc of the present invention can advantageously be used with a wider range of pads, such as with sintered metal pads and pads with a ceramic matrix.

Further features and advantages of the present invention will be more apparent from the description of some embodiments, given below by way of non-limiting example.

### BRIEF DESCRIPTION OF THE DRAWINGS

FIG. 1 diagrammatically shows a section view of a shaped material to form a disc brake disc according to an embodiment of the present invention.

FIG. 2 shows a graph showing the weight gain of a disc made of “C/C” material subjected to LSI on only one braking band and a disc made of “C/C” material subjected to LSI on both braking bands.

FIG. 3 shows images obtained by SEM, at different distances from the outer surface (top figure: distance from the surface of about 4 mm; bottom figure: distance from the surface of about 8 mm), of a shaped material according to the invention in which the outer layer made of carbon-ceramic material has a thickness of about 8 mm.

### DETAILED DESCRIPTION OF THE INVENTION

The present invention relates to a shaped material as well as a disc brake disc made from said shaped material in which the braking bands, the outer surfaces of which (so-called braking surfaces) are adapted to cooperate with the pads of a disc brake, are made of a carbon-ceramic material comprising carbon and silicon carbide, while the core of the disc delimited by the inner surfaces of said braking bands is made of a “C/C” carbonaceous material.

Since the braking bands which define the tribologically active part of the disc are made of carbon-ceramic material, they have greater mechanical strength and increased wear resistance, resulting in increased disc life and reduced particulate emission into the environment. At the same time, the disc core retains the performance in terms of lightness and thermal conductivity characterizing the “C/C” materials, making the disc suitable for being used in high-performance and sports car braking systems.

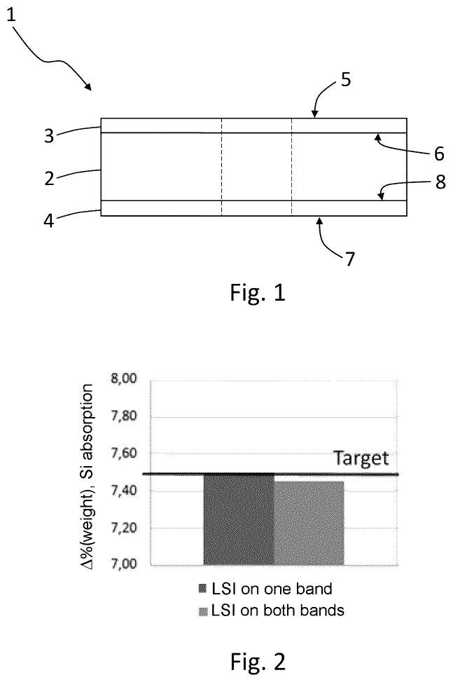

A cross-section of a shaped material of the present invention is shown in FIG. 1. More specifically, said material is shaped to form a disc brake disc, and the central hole of the disc is dashed in the section in FIG. 1.

The shaped material in FIG. 1 is indicated as a whole by reference numeral 1 and comprises, or consists of, an inner layer 2 made of a carbon-based “C/C” material, and two outer layers, a first outer layer 3 and a second outer layer 4, respectively, made of a carbon-ceramic material comprising carbon and silicon carbide (SiC). Preferably, said outer layer 3 and said outer layer 4 have substantially the same thickness.

Said first outer layer 3 forms a first braking band of the disc brake disc and is delimited by a first outer surface 5 (“first braking surface”), intended to cooperate with a brake pad, and by a corresponding inner surface 6.

Said second outer layer 4 forms a second braking band of the disc brake disc and is delimited by a second outer surface 7 (“second braking surface”), intended to cooperate with a brake pad, and by a corresponding inner surface 8.

Said inner layer 2 forms the disc core, which is delimited by the aforesaid inner surfaces 6, 8 of the braking bands. In the inner layer 2, ventilation channels (not shown in FIG. 1) of a ventilated-type disc brake disc are typically made; the ventilation channels can take variable and complex shapes and sizes since they can also be made with disposable cores, but preferably by mechanical processing.

Advantageously, the inner layer 2 and the respective outer layers 3, 4 extend substantially over the entire surface area of the shaped material 1.

According to a first embodiment, the two outer layers 3, 4 of the shaped material are made of a carbon-ceramic material comprising short, disordered filaments essentially consisting of carbon. Preferably, said filaments have a length less than 30 mm, e.g., between 6 and 24 mm.

The term “filaments essentially consisting of carbon” means fibrous materials typically produced by pyrolysis of various products of synthetic origin, e. g., polyacrylonitrile (PAN), or pitches.

Said filaments normally consists of fiber bundles comprising 3000 to 50000 fibers, in which the single fiber is generally 8-10 microns in diameter.

According to a second embodiment, the two outer layers 3, 4 of the shaped material are made of a carbon-ceramic material comprising spun fibers (yarn) and/or continuous long fibers (tow) essentially consisting of carbon and arranged to form a woven fabric and/or a non-woven fabric. The term “continuous long fibers” means bundles of fibers having a high length-to-diameter ratio (typically exceeding 10000:1). The term “spun fibers” means bundles of fibers spun to form a single yarn.

Preferably, the carbon-ceramic material of said outer layers 3, 4 comprises:
carbon fibers 10-40%, preferably about 15-30%
carbon matrix 30-70%, preferably about 40-60%
silicon 0-10%, preferably about 0-5%
SiC 10-40%, preferably 20-30%.

The aforesaid percentages are percentages by weight.

More preferably, the carbon-ceramic material of the outer layers 3, 4 comprises:
carbon fibers 15-25% by weight
carbon matrix 45-55% by weight
silicon 3-4% by weight
SiC 23-28% by weight.

For the purposes of the present invention, the term “comprises” also includes the meaning of “consisting of” or “essentially consisting of”.

Preferably, said outer layers 3, 4 of carbon-ceramic material have a porosity of less than 5%, or less than 4%, or less than 3%, or less than 2%.

Preferably, said outer layers 3, 4 of carbon-ceramic material have a density between 1.7 g/cm³ and 2.5 g/cm³, or between 1.8 g/cm³ and 2.4 g/cm³, or between 1.9 g/cm³ and 2.3 g/cm³.

Preferably, the “C/C” material of the inner layer 2 comprises:
carbon fibers 15-60%, preferably 20-40%
carbon matrix 40-85%, preferably 60-80%.

The aforesaid percentages are percentages by weight.

For the purposes of the present invention, the term “comprises” also includes the meaning of “consisting of” or “essentially consisting of”.

Preferably, said inner layer 2 made of “C/C” material has a porosity between 5% and 20%, or between 5% and 10%.

Preferably, said inner layer 2 made of “C/C” material has a density between 1.5 g/cm³ and 1.9 g/cm³, or between 1.6 g/cm³ and 1.8 g/cm³.

Such porosity and density values of the inner layer 2 made of “C/C” material are such as to give lightness to the shaped material.

The porosity of the outer layers 3, 4 and inner layer 2 is measured in water according to the hydrostatic weighing technique according to standard ISO 18754:2020.

The density of the outer layers 3, 4 and inner layer 2 is measured geometrically.

Preferably, the thickness of each of said outer layers 3, 4 is at least 4%, or at least 4.5%, or at least 5% of the thickness of the shaped material.

Preferably, the thickness of each of said outer layers 3, 4 is not exceeding 25%, or not exceeding 20%, or not exceeding 15%, or not exceeding 10% of the thickness of the shaped material.

According to a preferred embodiment, the thickness of each of said outer layers 3, 4 is between 0.5 and 10 mm. Preferably, said thickness is at least 1 mm, or at least 2 mm, or at least 3 mm, or at least 4 mm. Preferably, said thickness is not exceeding 8 mm, or not exceeding 7 mm, or not exceeding 6 mm. For example, said thickness is between 2 and 8 mm, or between 4 and 8 mm.

The above thickness values of the outer layers 3, 4 are to be intended as average values; this means that said layers do not necessarily have the same thickness along the entire surface area of the shaped material. For example, close to the edges of the shaped material, the thickness of the outer layers can be greater; said variability in thickness can be of the order of ±2 mm. This is more apparent with reference to the method of making the shaped material according to the invention, which comprises a step of infiltrating silicon into a “C/C” material, as will be described d below. During said infiltration step, the rise of silicon by capillarity can be greater at the edges due to the heterogeneous microstructure of the material and the edge effects in the lateral areas of the material.

The outer layers 3, 4 of the shaped material, forming the braking bands of a disc brake disc, are subject to wear. Therefore, the thickness of said layers must be such as to withstand the wear phenomenon so as to avoid the exposure of the underlying “C/C” material, ensuring the longest possible service life of the disc. At the same time, the thickness of said layers must not be too great, otherwise the material would become too heavy. The above thickness values are the right compromise between these two aspects.

Preferably, the thickness of the inner layer 2 is at least 50%, or at least 55%, or at least 60%, or at least 65%, or at least 70%, or at least 75% of the thickness of the shaped material.

Preferably, the thickness of the inner layer 2 is not exceeding 92%, or not exceeding 90%, or not exceeding 85%, or not exceeding 80% of the thickness of the shaped material.

Advantageously, the shaped material of the present invention is mono-block, since it is made from a single block of “C/C” material, as will be even more apparent from the following description of the making method thereof.

The shaped material of the invention is obtained by a method according to the claims. In particular, said method comprises the following steps in sequence:
a) preparing a carbon-densified blank of “C/C” material, said blank having two opposite surfaces, a first surface and a second surface, respectively;
b) optionally making ventilation and/or feeding channels characterizing a disc brake disc;
c) putting the first surface and the second surface of said carbon-densified blank of “C/C” material into contact with silicon, either simultaneously or sequentially, so that at least part of the silicon infiltrates said blank for a predetermined thickness from said first surface (also referred to as the “first thickness” in the present application) and for a predetermined thickness from said second surface (also referred to as the “second thickness” in the present application), thus obtaining a shaped material comprising said first outer layer and said second outer layer made of a carbon-ceramic material comprising carbon and silicon carbide;
d) optionally, subjecting to finishing the shaped material obtained in step c).

The phrase “carbon-densified blank of “C/C” material”, also referred to as a “blank” or “C/C blank” in the present application, denotes a preform made of “C/C” material which has undergone a carbon densification process, as will be apparent from the description below.

### Step a) of the Method of Invention

### First Embodiment

According to a first embodiment, during said step a) a carbon-densified blank of “C/C” material is prepared from a corresponding preform, comprising spun fibers (yarn) and/or continuous long fibers (tow) essentially consisting of carbon and arranged to form a woven fabric and/or a non-woven fabric. The preparation of said preform is carried out by known methods. An example is described in WO 2019/180550.

According to an embodiment, said step a) of preparing the carbon-densified blank of “C/C” material comprises the following steps in sequence:
i) superimposing layers of carbon or carbon precursor fibers in the form of woven fabric and/or non-woven fabric to form a preform model;
ii) needle-punching the superimposed layers of fibers to form a three-dimensional intertwined structure;
iii) optionally, carbonizing the carbon precursor fibers into carbon fibers;
iv) optionally, impregnating the preform model obtained in steps i), ii), or iii) with resins;
v) optionally, subjecting the preform model obtained in one of the steps i), ii), iii), or iv) to a thermal pretreatment;
vi) subjecting the preform model obtained in one of the steps ii), iii), iv) or v) to a carbon densification process, preferably up to a material density exceeding 1.5 g/cm³ or exceeding 1.7 g/cm³, to form a carbon-densified blank of “C/C” material;
vii) subjecting the blank obtained in step vi) to a heat treatment.

In step i), the layers can comprise either carbon fibers (i.e., already carbonized fibers) or precursors to such fibers (preferably PAN, pitch, or rayon) which are transformed into carbon fibers during the carbonization step iii) following the needle-punching. Carbonization typically includes heating the fibers to a temperature between 1500° C. and 2000° C., varying as a function of the type of precursor.

According to an embodiment, the preform model is cylindrical in shape, with an axis parallel to the superimposition axis of the fiber layers.

The needle-punching in step ii) can be conducted using conventional methods including the use of appropriate needles which engage part of the fibers by directing them axially and allowing three-dimensional structures to be obtained.

The resins used in the impregnation step iv) are selected, for example, from the group consisting of phenolic resins, acrylic resins, polystyrene resins, furan resins, or cyano-esters.

The heat treatments in steps v) and vii) are such as to give high thermal conductivity to the material. Preferably, such heat treatments comprise treatment in an inert atmosphere or vacuum furnace up to temperatures between 1800 and 2550° C.

### Second Embodiment

According to a second embodiment, during said step a) a carbon-densified blank of “C/C” material comprising short and disordered filaments essentially consisting of carbon is prepared, where said filaments preferably have a length of less than 30 mm, e.g., between 6 and 24 mm. The preparation of said blank is carried out by known methods.

According to an embodiment, said step a) of preparing the carbon-densified blank of “C/C” material comprises the following steps in sequence:
i) printing short carbon or carbon precursor fibers mixed with resins to form a preform model, said resins being preferably phenolic resins, acrylic resins, paraffin, pitches, furan resins, or polystyrene;
ii) pyrolyzing the preform model obtained in step i);
iii) subjecting the preform model obtained in step ii) to a carbon densification process, preferably up to a material density exceeding 1.5 g/cm³ or exceeding 1.7 g/cm³, to form a carbon-densified blank of “C/C” material;
iv) subjecting the blank obtained in step iii) to a heat treatment.

During step i), fibers of either carbon or a precursor of such fibers (preferably PAN, pitch, or rayon) can be molded. Said molding step i) is preferably carried out by operating at temperatures between 80° C. and 200° C., preferably between 120° C. and 180° C., and/or at a pressure between 5 and 250 bar, preferably between 5 and 100 bar.

The preform model removed from the mold undergoes the pyrolysis step ii) so as to carbonize the binding resins. Preferably, step ii) is conducted in a conventional furnace at a temperature depending on the type of resin used, generally between 800° C. and 1000° C. Advantageously, the pyrolysis step ii) is conducted under the flow of an inert gas such as nitrogen or argon and at a pressure preferably between 10 and 1000 mbar, preferably of 500-1000 mbar. The inert gas flow also has the function of advantageously removing gases released by the pyrolysis of resins.

The heat treatment in step iv) is such as to give high thermal conductivity to the material, and preferably comprises treatment in an inert atmosphere or vacuum furnace up to temperatures between 1800 and 2550° C.

According to different embodiments, the carbon densification process of the preform comprising spun and/or continuous fibers arranged to form a woven fabric or a non-woven fabric (first embodiment described above) as well as of the preform comprising short and disordered filaments (second embodiment described above) is conducted with different methods.

A first method is CVD (Chemical Vapour Deposition) or CVI (Chemical Vapour Infiltration), depending on whether there is only a coating or a carbon infiltration in vapor form. Typically, if the material is fibrous and thus has high porosity, it is Chemical Vapor Infiltration (CVI). These methods include using hydrocarbon mixtures (e.g., methane and propane) and exposing the material to be treated to such mixtures at high temperatures and low pressures. The operating temperatures are of the order of 900-1200° C., preferably 1000-1100° C., and the operating pressures are less than 300 mbar, preferably a few tens of mbar. The hydrocarbon mixtures decompose to form elemental carbon, which is then deposited or infiltrated into the matrix of the material to be treated. This method, which requires the of furnaces, includes use dedicated depositing a thin layer (typically a few microns) on the fibers, whereby several cycles of infiltration and total coatings on the fibers exceeding ten microns (typically 20-30 microns) are required to obtain the desired densification.

A different method, known as LPI (Liquid Polymer Infiltration) o PIP (Polymer Infiltration and Pyrolysis), includes infiltrating the matrix of the material to be treated with a liquid polymer and then thermally treating it at high temperature (pyrolysis), which causes the carbonization of the polymer deposited on the carbon fibers. Again, several steps of infiltration and pyrolysis are required before obtaining an appropriate densification of the preform.

Regardless of the method used for the carbon densification step, the density of the material of the obtained blank is typically greater than 1.5 g/cm³.

### Step b) of the Method of the Invention (Optional)

During step b), the carbon-densified blank of “C/C” material obtained in step a) undergoes an initial processing, or pre-processing.

Said step b) can comprise a step of shaping the blank (i.e., densified preform), during which it is cut out to the nearly finished shapes and sizes of the disc brake disc. Alternatively, the shaping operation can be conducted on the individual fiber layers, either before the superimposition step i) or the needle-punching step ii), or on the needle-punched multilayer body downstream of step ii). Optionally, said shaping step is carried out in the case of blanks obtained from preforms comprising spun and/or continuous fibers; a preform comprising short, disordered filaments can take the desired shape in the appropriate mold.

Ventilation channels of a ventilated-type brake disc and/or feeding channels are also made during said step b). The term “feeding channels” means the holes by means of which the bell of the disc is then attached.

### Step c) of the Method of Invention

During step c) of the method of making the shaped material according to the present invention, the two surfaces of the carbon-densified blank of “C/C” material, optionally subjected to the aforesaid step b), are put into contact with silicon.

According to a first embodiment, the first surface and the second surface of the blank are simultaneously put into contact with silicon. In this embodiment, the silicon simultaneously infiltrates the blank for a predetermined thickness from said first surface (“first thickness”) and for a predetermined thickness from said second surface (“second thickness”), to form the two outer layers 3, 4 of the shaped material.

According to a second embodiment, the first surface and the second surface of the blank are sequentially put into contact with silicon. This means that the first surface of the blank is first put into contact with silicon so that at least part of the silicon infiltrates the blank for a predetermined thickness from said first surface (“first thickness”) to form the first outer layer 3 of the shaped material; the second surface of the blank is then put into contact with silicon so that at least part of the silicon infiltrates the blank for a predetermined thickness from said second surface (“second thickness”) to form the second outer layer 4 of the shaped material.

Preferably, the infiltration thickness of silicon from said first surface (“first thickness”) and said second surface (“second thickness”) is at least 4%, or at least 4.5%, or at least 5% of the thickness of the blank.

Preferably, the infiltration thickness of silicon from said first surface (“first thickness”) and said second surface (“second thickness”) is not exceeding 25%, or not exceeding 20%, or not exceeding 15%, or not exceeding 10% of the thickness of the blank.

Preferably, said first thickness and said second thickness are substantially the same.

According to a first embodiment (simultaneous infiltration of silicon from two surfaces), said step c) comprises the following steps:
c1) laying the blank on a first layer comprising silicon, preferably solid silicon, on the side of the first surface, and depositing a second layer comprising silicon, preferably solid silicon, on the second surface of the blank, opposite to the first one;
c2) subjecting the blank in contact with said first and second layers comprising silicon to a temperature such that at least part of the silicon infiltrates the blank by capillarity for said first thickness and said second thickness.

According to a second embodiment (sequential infiltration of silicon from two surfaces), said step c) comprises the following steps:
c1) laying the blank on a first layer comprising silicon, preferably solid silicon, on the side of the first surface;
c2) subjecting the blank laying on said first layer comprising silicon to a temperature such that at least part of the silicon infiltrates the blank by capillarity for said first thickness;
c1-bis) laying the material resulting from said step c2) on a second layer comprising silicon, preferably solid silicon, on the side of the second surface;
c2-bis) subjecting the material laying on said second layer comprising silicon to a temperature such that at least part of the silicon infiltrates the material by capillarity for said second thickness.

In an embodiment, the aforesaid layers comprise solid silicon. Said layers can comprise one or more materials in addition to solid silicon, e.g., boron carbide (B₄C). According to this embodiment, boron carbide is present in a layer in a percentage by weight preferably between 5% and 50%, more preferably between 5% and 20%.

In another embodiment, the aforesaid layers consist of solid silicon.

The solid silicon can be in pure form or silicon/aluminum or silicon/copper alloy and comes in granules or powder.

Hereafter, the term “silicon layer” is used with reference to both a layer comprising solid silicon and a layer consisting of solid silicon.

According to an embodiment, during steps c1) and c1-bis), the material is laid directly on the silicon layer. The term “directly” relates to the fact that the material is in contact with the silicon layer and there are no additional means or elements interposed between the material and the silicon layer.

According to another embodiment, during steps c1) and c1-bis), the material is laid on the silicon layer through external means or elements, e.g., porous partitions such as felts, pyrolyzed wood elements, or pegs. In this embodiment, during steps c1) and c1-bis), the material is not in contact with the silicon embedded in the layer; it will come into contact with the silicon during the subsequent infiltration steps c2) and c2-bis).

Preferably, the silicon infiltration steps c2) and c2-bis) are conducted in an appropriate treatment chamber, provided with vents for the gases released during the treatment.

The infiltration steps c2) and c2-bis) advantageously comprise an LSI (liquid silicon infiltration) process, during which the silicon layer is subjected to a temperature above the melting temperature of silicon, preferably at a temperature above 1410° C., more preferably between 1420° C. and 1700° C., so that the silicon melts and infiltrates the preform by capillary for said first thickness and said second thickness.

According to this embodiment, the treatment chamber is preferably introduced into an appropriate furnace of the conventional type, which is heated at the aforesaid temperature, e.g., at about 1500° C. At this temperature, silicon melts and infiltrates the pores of the surfaces in contact with silicon and reacts with some of the carbon in the carbon fibers and/or carbon matrix to form silicon carbide (SiC). Preferably, a portion of the molten silicon reacts with carbon to give silicon carbide and a portion of silicon remains unreacted. The unreacted silicon solidifies within the material during a cooling step. Both the heating to the treatment temperature and the subsequent cooling are conducted gradually. For example, it can take up to 8 or more hours to reach a treatment temperature of about 1500° C. and a similar amount of time to cool the infiltrated material.

Preferably, the silicon infiltration steps c2) and c2-bis) are conducted at a reduced pressure between 20 mbar and 150 mbar, more preferably between 80 mbar and 120 mbar.

As an alternative to the process described above comprising the deposition of the material on a silicon layer and the infiltration of silicon by LSI, step c) of the method of the invention can include the impregnation of the blank with a silicone resin. According to this alternative embodiment, the blank is immersed in a silicone resin bath on the side of the first surface for a thickness substantially equal to the first thickness, then subjected to an impregnation step at a maximum temperature of 80° C., a subsequent resin polymerization step at a maximum temperature of 150° C., and finally a pyrolysis step to convert the resin into ceramic material at a temperature between 800 and 1000° C.; the impregnation and polymerization temperatures vary based on the type of resin. The resulting material is then immersed in a silicone resin bath on the side of the second surface for a thickness substantially equal to the second thickness, and the same impregnation, polymerization, and pyrolysis steps are repeated.

Preferably, the amount of silicon with which each of said first and second surfaces of the blank is put into contact is between 2% and 15% by weight, or between 3% and 12% by weight, or between 4% and 10% by weight, or between 5% and 7.5% by weight, with respect to the weight of said blank.

Said amount of silicon is such as to ensure the infiltration of silicon into the aforesaid first thickness and second thickness. In particular, said amount of silicon is that required to fill at least partially the porosity of the “C/C” material of the blank for a thickness from the first surface equal to said first thickness and for a thickness from the second surface equal to said second thickness. In particular, said amount of silicon is such that it does not fill the porosity of the inner layer made of “C/C” material which extends between the aforesaid first and second thicknesses.

The method of making the shaped material of the invention, as described above, causes the two outer layers made of carbon-ceramic material to have a non-homogeneous composition through their thickness; for example, close to the two outer surfaces, there can be a higher concentration of silicon and silicon carbide, which progressively decreases moving away from the surfaces.

It was experimentally found that the silicon with which the carbon-densified blank of “C/C” material comes into contact is completely absorbed. This means that the absorption of silicon by the blank is quantitative. This advantageously allows controlling the infiltration thickness by also adjusting the amount of silicon. In this regard, FIG. 2 shows a graph showing the weight gain, for a single infiltration step, of a carbon-densified blank of “C/C” material subjected to LSI on one surface only (left histogram) and on both surfaces (right histogram). The “target” is the amount of silicon used to come into contact with a surface.

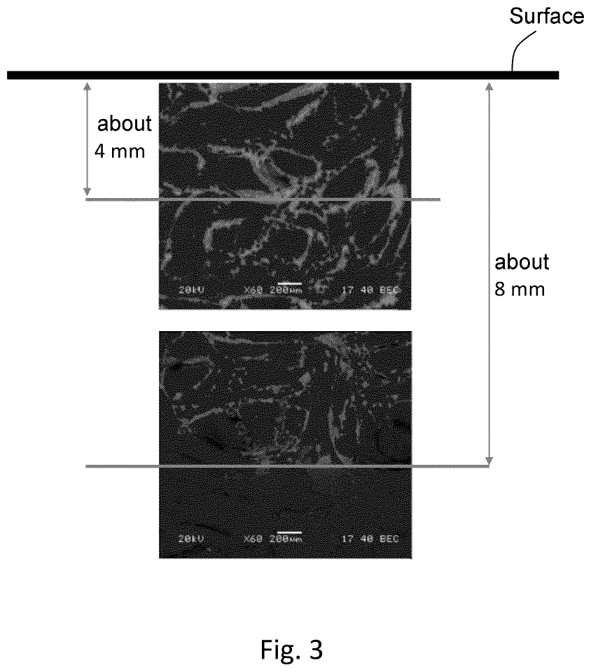

The infiltration thickness of silicon is monitored, for example by analyzing a section of the shaped material using SEM microscopy. FIG. 3 shows two images obtained by SEM, at different distances from the outer surface, of a shaped material according to the invention in which the outer layer made of carbon-ceramic material has a thickness of about 8 mm.

FIG. 3 shows (at the top) the image obtained by SEM at a distance of about 4 mm from the outer surface. It can be clearly seen that all the carbon porosities (in dark gray) are filled with silicon and silicon carbide (in lighter gray) and thus the material is carbon-ceramic.

FIG. 3 shows (at the bottom) the image obtained by SEM at a greater depth. The interface, about 8 mm from the surface, between the outer layer of the silicon-infiltrated material and the inner layer made of “C/C” material can be clearly seen. This shows that as the depth increases, the material becomes “C/C” again.

It was also experimentally verified that the shaped material of the present invention substantially retains the same thermal conductivity at 600° C. as a “C/C” material (70 W/mK). This means that, from a thermal point of view, ceramization does not change the material in a significant manner.

### Step d) of the Method of Invention (Optional)

During step (d), the material obtained in step c) undergoes a second processing, or finishing, during which the material is taken to the finished shapes and/or sizes of a disc brake disc. This final processing is often necessary because heat treatments can deform the shape of the shaped material. During step d), any surface deformation is then eliminated. Such a finishing treatment is preferably conducted dry, e.g., by means of diamond grinding wheels.

It is apparent that only one particular embodiment of the present invention was described. To both the shaped material and the method for obtaining it, those skilled in the art will be able to make all changes needed to adapt them to particular conditions, without however departing from the scope of protection as defined in the appended claims.

1-24. (canceled)

25. A shaped material comprising:
an inner layer made of a carbon-based material referred to as “Carbon-Carbon” or “C/C”, and
respective outer layers made of a carbon-ceramic material comprising carbon and silicon carbide, a first outer layer and a second outer layer, respectively.

26. The material according to claim 25, wherein said first outer layer and said second outer layer are made of a carbon-ceramic material comprising short and disordered filaments essentially consisting of carbon, wherein, preferably, said filaments have a length of less than 30 mm, e.g., between 6 and 24 mm.

27. The material according to claim 25, wherein said first outer layer and said second outer layer are made of a carbon-ceramic material comprising spun fibers (yarn) and/or continuous long fibers (tow) essentially consisting of carbon and arranged to form a woven fabric and/or a non-woven fabric.

28. The material according to claim 25, wherein the carbon-ceramic material of said first outer layer and said second outer layer comprises:
carbon fibers 10-40%, preferably about 15-30%
carbon matrix 30-70%, preferably about 40-60%
silicon 0-10%, preferably about 0-5%
SiC 10-40%, preferably 20-30%
said percentages being percentages by weight.

29. The material according to claim 25, wherein said first outer layer and said second outer layer have a porosity of less than 5%, or of less than 4%, or of less than 3%, or of less than 2%, and/or a density between 1.7 g/cm³ and 2.5 g/cm³, or between 1.8 g/cm³ and 2.4 g/cm³, or between 1.9 g/cm³ and 2.3 g/cm³.

30. The material according to claim 25, wherein the “C/C” material of said inner layer comprises:
carbon fibers 15-60%, preferably 20-40%
carbon matrix 40-85%, preferably 60-80%
said percentages being percentages by weight.

31. The material according to claim 25, wherein said inner layer has a porosity between 5% and 20%, preferably between 5% and 10%, and/or a density between 1.5 g/cm³ and 1.9 g/cm³, preferably between 1.6 g/cm³ and 1.8 g/cm³.

32. The material according to claim 25, wherein the thickness of each of said outer layers is at least 4%, or at least 4.5%, or at least 5% of the thickness of the shaped material, and/or not exceeding 25%, or not exceeding 20%, or not exceeding 15%, or not exceeding 10% of the thickness of the shaped material.

33. The material according to claim 32, wherein the thickness of each of said outer layers is between 0.5 and 10 mm, preferably between 2 and 8 mm, or between 4 and 8 mm.

34. The material according to claim 25, wherein the thickness of said inner layer is at least 50%, or at least 55%, or at least 60%, or at least 65%, or at least 70%, or at least 75% of the thickness of the shaped material, and/or not exceeding 92%, or not exceeding 90%, or not exceeding 85%, or not exceeding 80% of the thickness of the shaped material.

35. The material according to claim 25, wherein said material is shaped to form a disc brake disc.

36. A disc brake disc made from the shaped material according to claim 25, comprising:
a first braking band formed by said first outer layer of the shaped material, said first braking band being delimited by a first braking surface intended to cooperate with a brake pad and by a corresponding inner surface,
a second braking band formed by said second outer layer of the shaped material, said second braking band being delimited by a second braking surface intended to cooperate with a brake pad and by a corresponding inner surface,
a disc core formed by said inner layer of the shaped material, which extends between the inner surfaces of said first braking band and said second braking band.

37. A method for making the shaped material according to claim 25, comprising the following steps in sequence:
a) preparing a carbon-densified blank of “C/C” material, said blank having two opposite surfaces, a first surface and a second surface, respectively;
b) optionally making ventilation and/or feeding channels characterizing a disc brake disc;
c) putting the first surface and the second surface of said carbon-densified blank of “C/C” material into contact with silicon, either simultaneously or sequentially, so that at least part of the silicon infiltrates said blank for a predetermined thickness from said first surface (“first thickness”) and for a predetermined thickness from said second surface (“second thickness”), thus obtaining a shaped material comprising said first outer layer and said second outer layer made of a carbon-ceramic material comprising carbon and silicon carbide;
d) optionally, subjecting to finishing the shaped material obtained in step c).

38. The method according to claim 37, wherein the silicon infiltration thickness from said first surface and from said second surface is at least 4%, or at least 4.5%, or at least 5% of the thickness of the carbon-densified preform, and/or not exceeding 25%, or not exceeding 20%, or not exceeding 15%, or not exceeding 10% of the thickness of the blank.

39. The method according to claim 37, wherein during said step a) a carbon-densified blank made of “C/C” material is prepared, comprising spun fibers (yarn) and/or continuous long fibers (tow) essentially consisting of carbon and arranged to form a woven fabric and/or a non-woven fabric.

40. The method according to claim 39, wherein step a) of preparing said carbon-densified blank made of “C/C” material comprises the following steps in sequence:
i) superimposing layers of carbon or carbon precursor fibers in the form of woven fabric and/or non-woven fabric to form a preform model;
ii) needle-punching the superimposed layers of fibers to form a three-dimensional intertwined structure;
iii) optionally, carbonizing the carbon precursor fibers into carbon fibers;
iv) optionally, impregnating the preform model obtained in steps i), ii) or iii) with resins;
v) optionally, subjecting the preform model obtained in one of the steps i), ii), iii) or iv) to thermal pretreatment;
vi) subjecting the preform model obtained in one of the steps ii), iii), iv) or v) to a carbon densification process, preferably up to a material density exceeding 1.5 g/cm³ or exceeding 1.7 g/cm³, to form a carbon-densified blank made of “C/C” material;
vii) subjecting the blank obtained in step vi) to a heat treatment.

41. The method according to claim 37, wherein during said step a) a carbon-densified blank made of “C/C” material comprising short and disordered filaments essentially consisting of carbon is prepared, wherein, preferably, said filaments have a length of less than 30 mm, e.g., between 6 and 24 mm.

42. The method according to claim 41, wherein step a) of preparing said carbon-densified blank made of “C/C” material comprises the following steps in sequence:
i) molding short carbon fibers or carbon precursor mixed with resins to form a preform model, said resins being preferably phenolic resins, acrylic resins, paraffin, pitches, furan resins, or polystyrene;
ii) pyrolyzing the preform model obtained in step i);
iii) subjecting the preform model obtained in step ii) to a carbon densification process, preferably up to a material density exceeding 1.5 g/cm³ or exceeding 1.7 g/cm³, to form a carbon-densified blank made of “C/C” material;
iv) subjecting the blank obtained in step iii) to a heat treatment.

43. The method according to claim 37, wherein the amount of silicon with which each of said first and second surfaces of the carbon-densified preform is put into contact is between 2% and 15% by weight, or between 3% and 12% by weight, or between 4% and 10% by weight, or between 5% and 7.5% by weight, with respect to the weight of said preform.

44. The method according to claim 37, wherein step c) comprises the following steps:
c1) laying the blank on a first layer comprising silicon, preferably solid silicon, on the side of the first surface, and depositing a second layer comprising silicon, preferably solid silicon, on the second surface of the blank, opposite to the first one, and
c2) putting the blank into contact with said first and second layers comprising silicon to a temperature such that at least part of the silicon infiltrates the blank by capillarity for said first thickness and said second thickness.

45. The method according to claim 44, wherein step c2) comprises a liquid silicon infiltration (LSI) process conducted at a temperature above the silicon melting temperature, preferably at a temperature above 1410° C., more preferably between 1420° C. and 1700° C., and/or at a pressure preferably between 20 mbar and 150 mbar, more preferably between 80 mbar and 120 mbar.

46. The method according to claim 37, wherein step c) comprises the following steps:
c1) laying the blank on said first layer comprising silicon, preferably solid silicon, on the side of the first surface;
c2) subjecting the blank laying on said first layer comprising silicon to a temperature such that at least part of the silicon infiltrates the blank by capillarity for said first thickness;
c1-bis) laying the material resulting from said step c2) on a second layer comprising silicon, preferably solid silicon, on the side of the second surface;
c2-bis) subjecting the material laying on said second layer comprising silicon to a temperature such that at least part of the silicon infiltrates the material by capillarity for said second thickness.

47. The method according to claim 46, wherein step c2) and step c-2 bis) comprise a liquid silicon infiltration (LSI) process conducted at a temperature above the silicon melting temperature, preferably at a temperature above 1410° C., more preferably between 1420° C. and 1700° C., and/or at a pressure preferably between 20 mbar and 150 mbar, more preferably between 80 mbar and 120 mbar.

48. A shaped material as obtainable by the method according to claim 37.
